(19) United States
(12) Patent Application Publication
(10) Pub. No.: US 2015/0295212 A1
(43) Pub. Date: Oct. 15, 2015

(54) RECHARGEABLE BATTERY PACKING CONTAINER

(71) Applicant: SAMSUNG SDI CO., LTD., Yongin-si (KR)

(72) Inventor: Yup HWANGBO, Yongin-si (KR)

(21) Appl. No.: 14/618,197

(22) Filed: Feb. 10, 2015

(30) Foreign Application Priority Data
Apr. 14, 2014 (KR) 10-2014-0044404

(51) Int. Cl. H01M 2/10

(52) U.S. Cl. CPC H01M 2/1016

(57) ABSTRACT

A rechargeable battery packing container for rechargeable batteries, each with a first terminal, a second terminal, and a vent, includes a housing including a lower case and an upper case, the housing having a space to house the rechargeable batteries, cell barriers that divide the space in the housing into a plurality of parts, and a holder coupleable onto at least one rechargeable battery of the rechargeable batteries, the holder spacing the rechargeable batteries apart from the housing, and the holder including a support rib positioned to surround a side of the rechargeable battery and a plurality of protective projections protruding from the support rib.

### CROSS-REFERENCE TO RELATED APPLICATION

Korean Patent Application No. 10-2014-0044404, filed on Apr. 14, 2014, in the Korean Intellectual Property Office, and entitled: “Rechargeable Battery Packing Container,” is incorporated by reference herein in its entirety.

### BACKGROUND

1. Field

Embodiments relate to a rechargeable battery packing container.

2. Description of the Related Art

A rechargeable battery can be recharged and discharged repeatedly, unlike a primary battery, which cannot be recharged. Low capacity rechargeable batteries are used in small, portable electronic devices, e.g., mobile phones, laptop computers, and camcorders, and large capacity rechargeable batteries are widely used as power sources for driving motors, e.g., of hybrid vehicles and the like.

Recently, high power rechargeable batteries using non-aqueous electrolyte with high energy density have been developed. In order for such high power rechargeable batteries to be used for driving motors of machines requiring high power, such as electric vehicles, a plurality of rechargeable batteries may be coupled in series to form a large-capacity battery module.

A large-capacity battery module is generally formed of a plurality of rechargeable batteries which are coupled in series. A rechargeable battery may be formed in a cylindrical, angular, or other shape.

### SUMMARY

Embodiments are directed to a rechargeable battery packing container for rechargeable batteries each with a first terminal, a second terminal and a vent. The rechargeable battery packing container includes a housing including a lower case and an upper case, the housing having a space to house rechargeable batteries, cell barriers that divide the space in the housing into a plurality of parts, and a holder that is coupleable onto, or, for example, configured to be coupled onto at least one rechargeable battery of the rechargeable batteries, the holder spacing the rechargeable batteries apart from the housing, and the holder including a support rib surrounding or positioned to surround a side of the rechargeable battery and a plurality of protective projections protruding from the support rib.

The protective projections may be spaced at intervals along a lengthwise direction of the support rib.

The protective projections may contact the cell barriers.

The holder may include a plate part having a rectangular plate shape and having long sides and short sides. The support rib may protrude from a side edge of the plate part. The protective projections may include first protective projections and second protective projections. The first protective projections may be on the long sides of the support rib. The second protective projections may be on the short sides of the support rib, the second protective projections protruding further from the support rib than the first protective projections.

The holder may include a first protruding part positioned to be alignable with, or, for example, configured to be over, the first terminal of the rechargeable battery.

A first buffer recess may be located under the first protruding part so as to provide a first terminal accommodating space above the first terminal.

The holder may include a second protruding part positioned to be alignable with, or, for example, configured to be over, the second terminal of the rechargeable battery. A second buffer recess located so as to provide a second terminal accommodating space above the second terminal may be located under the second protruding part.

An upper buffer plate may be between the cell barriers and a top inner surface of the housing. A lower buffer plate may be between the cell barriers and a bottom inner surface of the housing.

Top edges of the first protruding part and second protruding part may include support projections that contact the upper buffer plate.

The holder may include a third protruding part positioned or, for example, configured to be above the vent of the rechargeable battery.

A third buffer recess providing a vent accommodating space above the vent may be located under the third protruding part.

The cell barriers may include first barriers extending in a first direction and second barriers extending in a direction crossing the first barriers.

The first barriers may include first edge projections that protrude outwardly from the second barriers. The second barriers may include second edge projections that protrude outwardly from the first barriers, the first edge projections and the second edge projections contacting the inner surface of the housing.

The holder may include a plate part having a flat shape. The support rib may include a plurality of first support ribs protruding from a bottom surface of the plate part and configured to surround sides of the rechargeable batteries, and a second support rib spaced apart from the first support ribs, the second support rib contacting an inner surface of the housing. The protective projections may protrude from the second support rib.

The holder may include a plurality of second support ribs. Top edges of the cell barriers may be insertable between the first support ribs and between the second support ribs.

The second support rib may include cutaway recesses that receive top edges of the cell barriers.

The holder may include a plurality of first protruding parts, each first protruding part of the plurality of first protruding parts being positioned to be alignable with, or, for example, configured to be over, the first terminal of a respective one of the rechargeable batteries, a plurality of second protruding parts, each second protruding part of the plurality of second protruding parts being positioned to be alignable with, or, for example, configured to be over, the second terminal of a respective one of the rechargeable batteries, a plurality of third protruding parts, each third protruding part of the plurality of third protruding parts being positioned to be alignable with, or, for example, configured to be over, the vent of a respective one of the rechargeable batteries.

### BRIEF DESCRIPTION OF THE DRAWINGS

Features will become apparent to those of skill in the art by describing in detail exemplary embodiments with reference to the attached drawings in which:

FIG. 1 illustrates an exploded perspective view showing a rechargeable battery packing container according to an exemplary embodiment.

FIG. 2 illustrates a cutaway cross-sectional view of the members of FIG. 1 coupled together.

FIG. 3 illustrates a perspective view showing a holder according to this exemplary embodiment.

FIG. 4 illustrates a cross-sectional view showing the holder and a rechargeable battery coupled together according to this exemplary embodiment.

FIG. 5 illustrates a perspective view showing a holder according to another exemplary embodiment.

FIG. 6 illustrates a cross-sectional view showing a rechargeable battery packing container according to the exemplary embodiment illustrated in FIG. 5.

### DETAILED DESCRIPTION

In the following detailed description, only certain exemplary embodiments have been shown and described, simply by way of illustration. As those skilled in the art would realize, the described embodiments may be modified in various different ways, all without departing from the spirit or scope. In addition, like reference numerals designate like elements in the present specification and drawings.

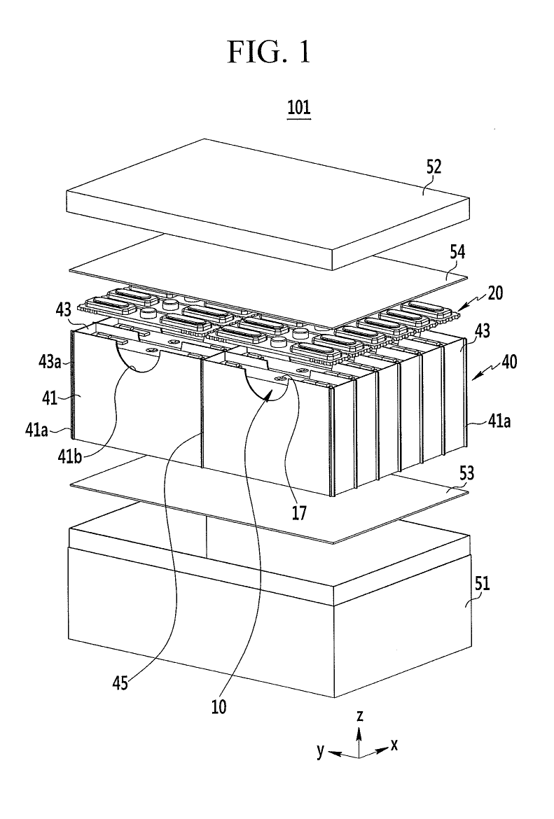

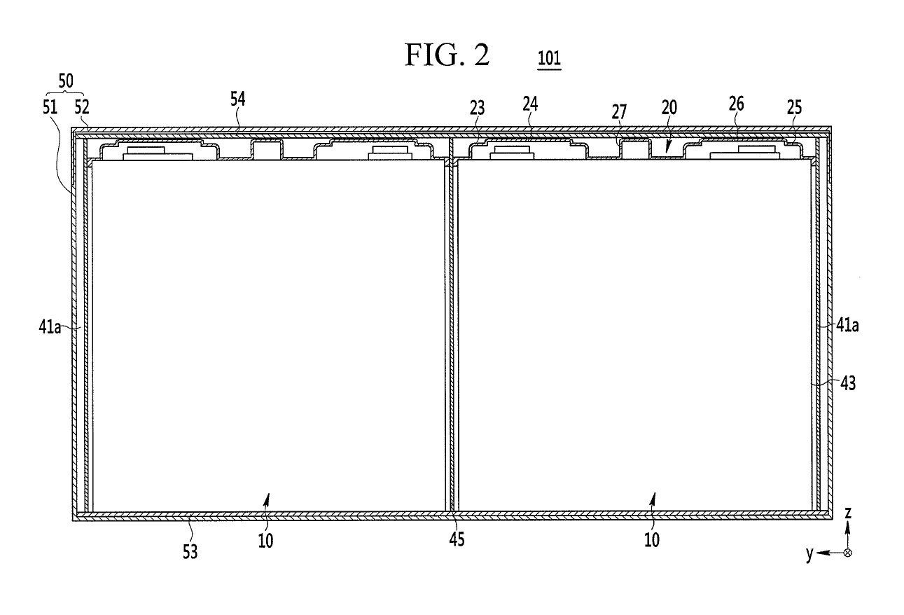

FIG. 1 illustrates an exploded perspective view showing a rechargeable battery packing container according to an exemplary embodiment. FIG. 2 illustrates a cutaway cross-sectional view of the members of FIG. 1 coupled together.

Referring to FIG. 1 and FIG. 2, a packing container 101 according to this exemplary embodiment includes a housing 50, cell barriers 40, a holder 20, a lower buffer plate 53, and an upper buffer plate 54.

The rechargeable battery 10 may be a general rechargeable battery 10, such as a lithium-ion battery or lithium-polymer battery, for example, having a case and an electrode assembly housed in the case for performing charging and discharging. The rechargeable battery 10 may be formed in an angular or cylindrical shape.

The housing 50 may form the space where rechargeable batteries are housed. The housing 50 may include a lower case 51 and an upper case 52 coupled to the lower case 51. The housing 50 may be in the form of a cube-shaped box, and the lower case 51 and the upper case 52 may fit together. A plurality of rechargeable batteries 10, i.e., approximately 10 to 30 rechargeable batteries, may be housed in the housing 50. The housing 50 may be made of paper or a polymer.

The cell barriers 40 may divide the inside of the housing 50 into a plurality of spaces. The cell barriers 40 may be made up of a plurality of plates that cross each other. The cell barriers 40 may be arranged between the rechargeable batteries 10. The cell barriers 40 may include first barriers 43 extending along the direction of the stack of the rechargeable batteries 10 (the x-axis direction of FIG. 1) and second barriers 41 extending in a direction crossing the first barriers 41. The first barriers 43 and the second barriers 41 may extend in a direction perpendicular to each other.

The first barriers 43 may be arranged to be parallel to the wide front surfaces of the rechargeable batteries 10, and the second barriers 41 may be arranged to be parallel to the side surfaces of the rechargeable batteries 10.

The first barriers 43 may include first edge projections 43a that protrude outwardly from the second barriers 41. and are formed on The second barriers 41 may include second edge projections 41a that protrude outwardly from the first barriers 43. The first edge projections 43a and the second edge projections 41a may contact the inner surface of the housing 50. When the first edge projections 43a and the second edge projections 41a contact the inner surface of the housing 50, the cell barriers 40 may be stably secured in the housing 50.

Cutaway parts may be formed on the top edges of the second barriers 41 to facilitate insertion or removal of the rechargeable batteries 10. Accordingly, the rechargeable batteries 10 may be easily inserted into and removed from the spaces formed by the cell barriers 40.

The lower buffer plate 53 may be arranged to be in contact with the bottom of the lower case 51. The lower buffer plate 53 may and serve to absorb impacts. The upper buffer plate 54 is arranged to be in contact with the bottom surface of the upper case 52. The lower buffer plate 53 and the upper lower plate 54 may be made of corrugated paper having a thickness. The cell barriers 40 may be arranged between the lower buffer plate 53 and the upper buffer plate 54.

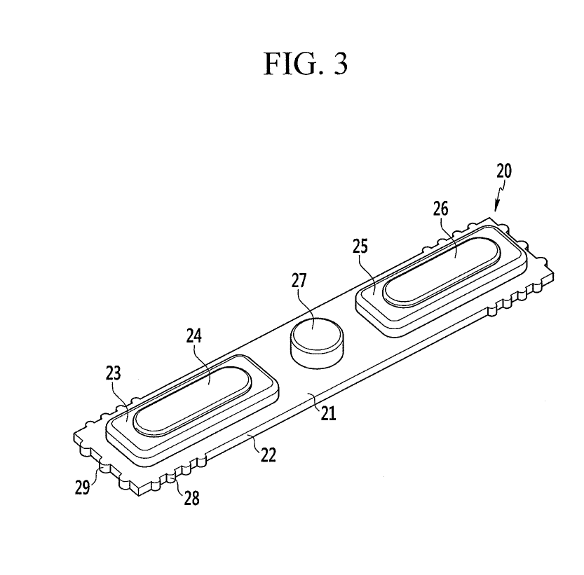

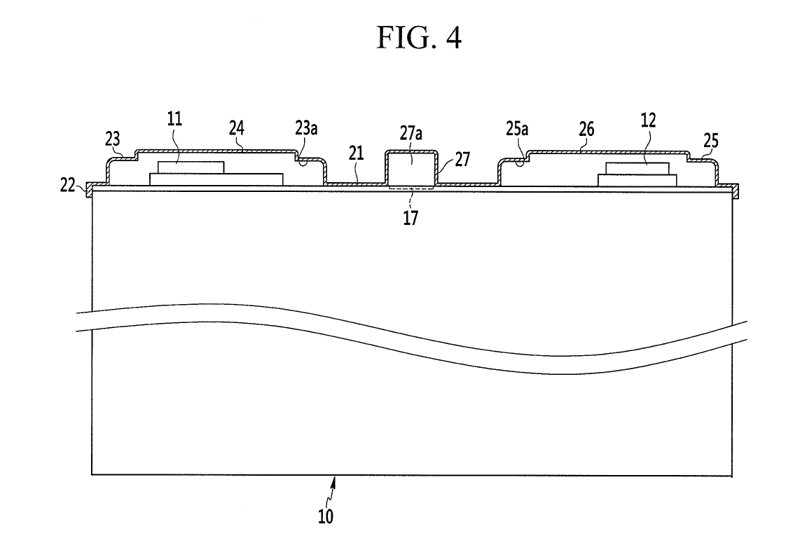

FIG. 3 illustrates a perspective view showing a holder according to this exemplary embodiment. FIG. 4 illustrates a cross-sectional view showing the holder and a rechargeable battery coupled together according to this exemplary embodiment.

Referring to FIG. 3 and FIG. 4, a holder 20 may be fit onto the top surface of a rechargeable battery 10. The holder 20 may be arranged between the rechargeable battery 10 and the upper buffer plate 54. One holder 20 may be coupled to the top edge of each rechargeable battery 10. The holder 20 may be inserted into one of the spaces formed by the cell barriers 40.

The holder 20 may include a plate part 21 having a flat shape, a support rib 22 protruding from the side edge of the plate part 21 and surrounding the side of the rechargeable battery 10, and protruding parts 23, 25, and 27 protruding upward from the plate part 21. The plate part 21 may have a rectangular plate shape, and may be arranged on top of the rechargeable battery 10.

The support rib 22 may be formed along the side edge of the holder 20, and may protrude toward the rechargeable battery 10. The support rib 22 may include a plurality of protective projections 28 and 29. The protective projections 28 and 29 may be spaced at intervals along the lengthwise direction of the support rib 22. The plate part 21 may have long sides and short sides, the short sides being shorter than the long sides. First protective projections 28 may be formed on the long sides of the support rib 22, and second protective projections 29, which, may be formed on the short sides of the support rib 22. The second protective projections 29 may protrude further than the first protective projections 28.

The second protective projections 29 may protrude higher than the first protective projections 28. The first protective projections 28 and the second protective projections 29 may support the rechargeable battery 10 to prevent the rechargeable battery 10 from moving, and from being in contact with the cell barriers 40.

The top surface of the rechargeable battery 10 may include a first terminal 11 connected to an anode, a second terminal 12 connected to a cathode, and a vent member 17 with a notch adapted to open in response to an abnormal pressure increase. The holder 20 may include a first protruding part 23 formed over the first terminal 11o, a second protruding part 25 formed over the second terminal 12, and a third protruding part 27 formed over the vent member 17. are mounted on. The first protruding part 23 may be formed over the first terminal 11 and may protrude in a curved manner. A first buffer recess 23a providing a space above the first terminal 11 may be formed under the first protruding part 23. A second buffer recess 25a providing a space above the second terminal 12 may be formed under the second protruding part 25. A third buffer recess 27a providing a space above the vent member 18 may be formed under the third protruding part 27.

The first buffer recess 23a and the second buffer recess 25a may prevent the top surfaces of the first and second terminals 11 and 12 from coming into contact with the packing material and may absorb external impacts. Moreover, the third buffer recess 27a may protect the vent member 17, which is easily breakable from impacts or pressure change.

The top edge of the first protruding part 23 may include a first support projection 24 in contact with the upper buffer plate 54. and is formed on The top edge of the second protruding part 25 may include a second support projection 26 in contact with the upper buffer plate 54. The first and second support projections 24 and 26 may serve to prevent the rechargeable battery 10 from moving upwardly and downwardly.

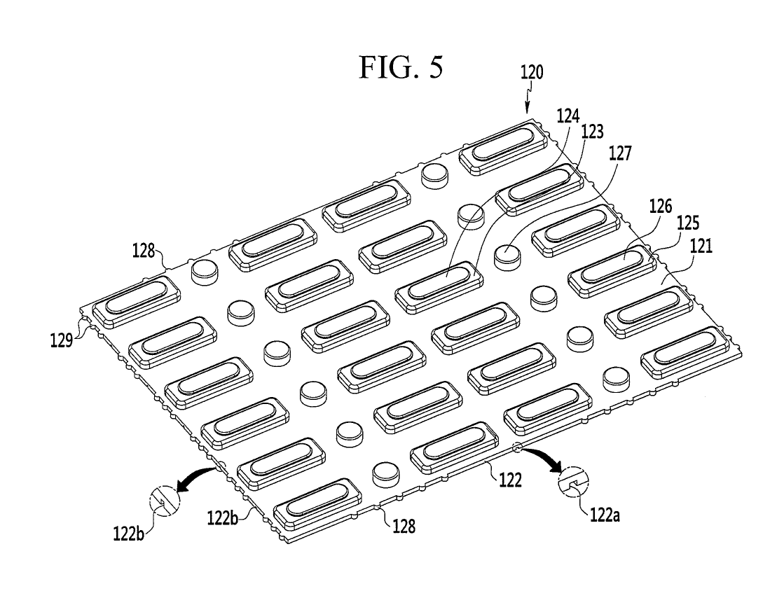

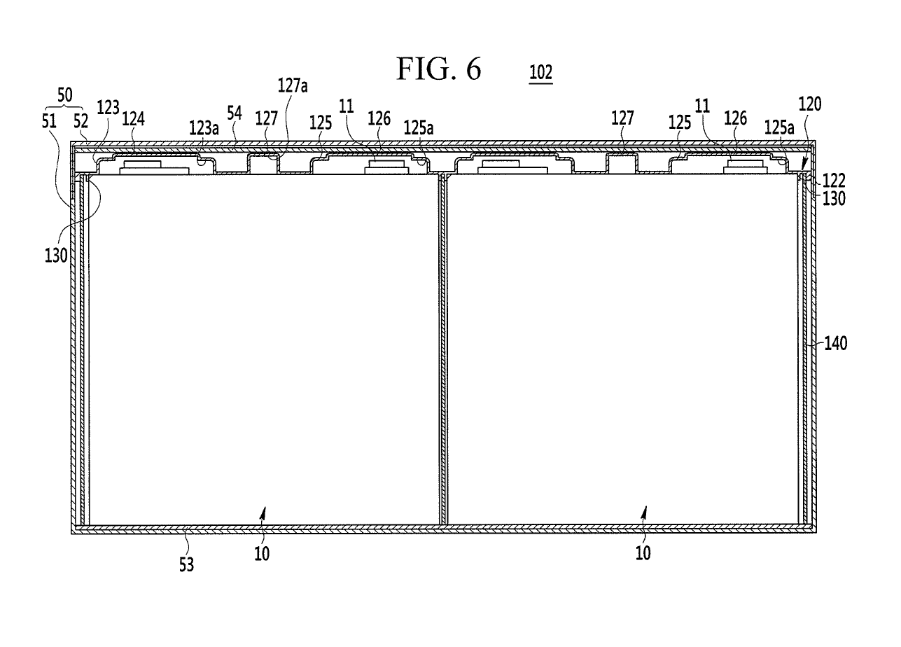

FIG. 5 illustrates a perspective view showing a holder according to another exemplary embodiment. FIG. 6 illustrates a cross-sectional view showing a rechargeable battery packing container according to this exemplary embodiment.

Referring to FIG. 5 and FIG. 6, a packing container 102 according to the present exemplary embodiment may include a housing 50, cell barriers 140, a holder 120, a lower buffer plate 53, and an upper buffer plate 54.

The housing 50 may form the space where rechargeable batteries are housed. The housing 50 may include a lower case 51 and an upper case 52 coupled to the lower case 51. The housing 50 may be in the form of a cube-shaped box, and the lower case 51 and the upper case 52 may fit together.

The cell barriers 40 may divide the inside of the housing 50 into a plurality of spaces. The cell barriers may be made up of a plurality of plates arranged to cross each other. The lower buffer plate 53 may contact the bottom of the lower case 51, and may serve to absorb impacts. The upper buffer plate 54 may contact with the bottom surface of the upper case 52.

A holder 120 may be fit onto the top surfaces of the rechargeable batteries 10, and may be arranged between the rechargeable batteries 10 and the upper buffer plate 54. A plurality of rechargeable batteries 10 may be fit onto one holder 120. The holder 120 may be arranged on top of the rechargeable batteries 10. The holder 120 may be made of a polymer.

The holder 120 may include a plate part 121 having a flat shape, a plurality of first support ribs 130 protruding from the bottom surface of the plate part 121 and surrounding the sides of the rechargeable batteries, and a second support rib 122 spaced apart from the first support ribs 130 and being in contact with the inner surface of the housing 50. The plate part 121 may be substantially rectangular.

A plurality of first support ribs 130 may be formed on the bottom surface of the plate part 121, and one rechargeable battery 10 may be fit to one first support rib 130. Accordingly, the holder 120 and the rechargeable batteries may be stably coupled together by the first support ribs 130. The first support ribs 130 may be in contact with the cell barriers 140. The top edges of the cell barriers 140 may fit between the first support ribs 130 and the second support rib 122.

The second support rib 122 may be formed along the circumference of the housing 50. The second support rib 122 may have protective projections 128 and 129 that contact the inner surface of the housing 50. The protective projections 128 and 129 may serve to prevent the holder 120 from swinging inside the housing 50 and coming into contact with the housing 50. The first support ribs 130 and the second support rib 122 may protrude downwardly toward the rechargeable batteries 10.

Cutaway recesses 122a and 122b may be formed on the second support rib 122 to fit the top edges of the cell barriers 140 in. When the cell barriers 140 are inserted into the cutaway recesses 122a and 122b, the holder 120 and the cell barriers 140 may support each other. Movement such as swinging of the holder 120 and the cell barriers 140 inside the housing 50 may be prevented or reduced.

Upward protruding parts 123, 125, and 127 may be formed on the plate part 121. The holder 120 may include a first protruding parts 123 formed over first terminals 11 of the rechargeable batteries, a second protruding parts 125 formed over second terminals 12 of the rechargeable batteries, and third protruding parts 127 formed over vent members of the rechargeable batteries.

First buffer recesses 123a forming a space above each first terminal 11 may be formed under the first protruding parts 123. Second buffer recesses 125a forming a space above each of the second terminals 12 may be formed under the second protruding parts 125. Third buffer recesses 127a forming a space above each vent member may be formed under the third protruding parts 127.

A support projection 124 may be formed on the top edge of each first protruding part 123 to be in contact with the upper buffer plate 54, and a support projection 126 may be formed on the top edge of each second protruding part 125 to be in contact with the upper buffer plate 54. The support projections 124 and 126 may serve to prevent the rechargeable battery 10 from moving upward and downward.

By way of summation and review, when transporting rechargeable batteries, there is a risk that black spots could appear on the surfaces of the rechargeable batteries due to friction between the rechargeable batteries and the packing material. For example, when rechargeable batteries are transported by air or the like over a long distance, continuous vibrations may be applied to the rechargeable batteries, which may cause friction between the rechargeable batteries. Such black spots could damage the products image, and additional operations to remove the black spots may be needed.

Embodiments provide a rechargeable battery packing container that may stably support rechargeable batteries such that black spots may be prevented. Black spots appearing on rechargeable batteries due to friction between the rechargeable batteries and the cell barriers or a housing may be avoided by mounting a holder in the housing to support the rechargeable batteries

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A rechargeable battery packing container for rechargeable batteries each with a first terminal, a second terminal, and a vent, the packing container comprising:
a housing including a lower case and an upper case, the housing having a space to house the rechargeable batteries;
cell barriers that divide the space in the housing into a plurality of parts; and
a holder coupleable onto at least one rechargeable battery of the rechargeable batteries, the holder spacing the rechargeable batteries apart from the housing, and the holder including a support rib positioned to surround a side of the rechargeable battery and a plurality of protective projections protruding from the support rib.

2. The rechargeable battery packing container as claimed in claim 1,
wherein the protective projections are spaced at intervals along a lengthwise direction of the support rib.

3. The rechargeable battery packing container as claimed in claim 2, wherein the protective projections contact the cell barriers.

4. The rechargeable battery packing container as claimed in claim 2, wherein:
the holder includes a plate part having a rectangular plate shape and having long sides and short sides,
the support rib protrudes from a side edge of the plate part,
the protective projections include first protective projections and second protective projections,
the first protective projections are on the long sides of the support rib, and
the second protective projections are on the short sides of the support rib, the second protective projections protruding further from the support rib than the first protective projections.

5. The rechargeable battery packing container as claimed in claim 1, wherein the holder includes a first protruding part positioned to be alignable with and over a first terminal of the rechargeable battery.

6. The rechargeable battery packing container as claimed in claim 5, wherein a first buffer recess is located under the first protruding part, the first buffer recess being positioned so as to provide a first terminal accommodating space above the first terminal.

7. The rechargeable battery packing container as claimed in claim 6, wherein:
the holder includes a second protruding part positioned to be alignable with and over the second terminal of the rechargeable battery, and
a second buffer recess being located so as to provide a second terminal accommodating space above the second terminal is located under the second protruding part.

8. The rechargeable battery packing container as claimed in claim 7, wherein an upper buffer plate is between the cell barriers and a top inner surface of the housing, and a lower buffer plate is between the cell barriers and a bottom inner surface of the housing.

9. The rechargeable battery packing container as claimed in claim 8, wherein top edges of the first protruding part and second protruding part include support projections that contact the upper buffer plate.

10. The rechargeable battery packing container as claimed in claim 1, wherein the holder includes a third protruding part positioned to be above the vent of the rechargeable battery.

11. The rechargeable battery packing container as claimed in claim 10, wherein a third buffer recess providing a vent accommodating space above the vent is located under the third protruding part.

12. The rechargeable battery packing container as claimed in claim 1, wherein the cell barriers include first barriers extending in a first direction and second barriers extending in a direction crossing the first barriers.

13. The rechargeable battery packing container as claimed in claim 12, wherein:
the first barriers include first edge projections that protrude outwardly from the second barriers, and
the second barriers include second edge projections that protrude outwardly from the first barriers, the first edge projections and the second edge projections contacting an inner surface of the housing.

14. The rechargeable battery packing container as claimed in claim 1, wherein:
the holder includes a plate part having a flat shape,
the support rib includes a plurality of first support ribs protruding from a bottom surface of the plate part and configured to surround sides of the rechargeable batteries, and a second support rib spaced apart from the first support ribs, the second support rib contacting an inner surface of the housing, and
the protective projections protrude from the second support rib.

15. The rechargeable battery packing container as claimed in claim 14, wherein:
the holder includes a plurality of second support ribs, and
top edges of the cell barriers are insertable between the first support ribs and between the second support ribs.

16. The rechargeable battery packing container as claimed in 14, wherein the second support rib includes cutaway recesses that receive top edges of the cell barriers.

17. The rechargeable battery packing container as claimed in claim 14, wherein the holder includes:
a plurality of first protruding parts, each first protruding part of the plurality of first protruding parts being positioned to be alignable and over the first terminal of a respective one of the rechargeable batteries,
a plurality of second protruding parts, each second protruding part of the plurality of second protruding parts being positioned to be alignable and over the second terminal of a respective one of the rechargeable batteries,
a plurality of third protruding parts, each third protruding part of the plurality of third protruding parts being positioned to be alignable and over the vent of a respective one of the rechargeable batteries.
